(19) United States
(12) Patent Application Publication
(10) Pub. No.: US 2012/0213560 A1
(43) Pub. Date: Aug. 23, 2012

(54) IMAGE FORMING APPARATUS

(75) Inventor: Yuhei Takei, Abiko-shi (JP)

(73) Assignee: CANON KABUSHIKI KAISHA, Tokyo (JP)

(21) Appl. No.: 13/400,887

(22) Filed: Feb. 21, 2012

(30) Foreign Application Priority Data
Feb. 21, 2011 (JP) 2011-034487

(51) Int. Cl. G03G 15/20

(52) U.S. Cl. 399/308

(57) ABSTRACT

An image forming apparatus includes a shaft rotatably supporting a supporting member on a supporting unit to allow switching while maintaining the supporting unit, between a first state in which first and second members contact an intermediary transfer belt in a first image forming mode, and a second state in which the first transfer member contacts the belt and the second transfer member is spaced from the belt, in a second image forming mode. The supporting shaft is disposed in a range which is downstream of a central portion of the first transfer member which is disposed downstreammost with respect to a moving direction of the belt and which is remote from a surface of the belt beyond a plane including the central portion of the first transfer member and parallel with a surface of the belt facing the first transfer member.

### FIELD OF THE INVENTION AND RELATED ART

The present invention relates to an image forming apparatus which can be operated in a color mode for obtaining a multicolor image, or in a black-and-white mode for obtaining a black-and-white image.

There have been known various electrophotographic color image forming apparatuses of the so-called tandem type. An electrophotographic color image forming apparatus of the tandem type is not always required to output an image in color (Y, M, C and Bk). That is, it is not infrequently that it is required to output only a black-and-white (Bk) image. Thus, some electrophotographic color image forming apparatuses of the tandem type are structured so that when they are used for outputting only a black-and-white image, a certain amount of distance is kept between the primary transferring member of each of the yellow, magenta, and cyan image formation stations Y, M and C and the corresponding image bearing member (drum) in order to extend the image bearing drums and developing devices (Y, M and C) of the yellow, magenta, and cyan image forming stations (Y, M and C).

For example, some of them are structured so that the primary transfer rollers of the image formation stations Y, M and C are orbitally movable about a preset point to be moved toward, or away from, the image bearing drums of the corresponding image formation stations to be pressed against, or moved away, from the image bearing drums, to place the intermediary transferring member in contact with the image bearing drums, or to allow the intermediary transfer member to separate from the image bearing drums. Further, they are structured so that as the primary transfer rollers of the image formation stations, Y, M and C are orbitally moved about the preset point, the intermediary transfer member is bent along the peripheral surface of the primary transfer roller of the black image formation station Bk in such a curvature that the center of the curvature coincides with the axial line of the primary transfer roller of the black image formation station Bk (Japanese Laid-open Patent Application 2008-151976). There are also electrostatic color image forming apparatuses structured so that the primary transfer rollers of the image formation stations Y, M and C are movable relative to the intermediary transferring member in the vertical direction to the intermediary transferring member to be pressed against the image bearing drums to place the intermediary transferring member in contact with the image bearing members, or to be moved in the direction to be moved away from the image bearing members to allow the intermediary transferring member to separate from the image bearing drums (Japanese Laid-open Patent Application 2009-128580).

However, color image forming apparatuses based on the above described background technologies suffer from the following problems. For example, in the case of the image forming apparatus disclosed in Japanese Laid-open Patent Application 2008-151976, its intermediary transfer belt unit is pivotally moved about the axial line of the primary transfer roller of the black image formation station Bk to move the primary transfer rollers of the image formation stations Y, M and C in the direction to be moved away from the image bearing drums of the image formation stations Y, M and C. Therefore, while the primary transfer rollers of the image formation stations Y, M, and C are moved in the direction to be moved away from the image bearing drums, the roller for backing up the primary transfer belt to clean the primary transfer belt is also moved. Thus, the passage through which the toner recovered by the cleaning device of the image forming apparatus is conveyed is complicated. Therefore, this image forming apparatus is rather high in cost.

Further, when the primary transfer roller of each of the image formation stations Y, M and C is pressed against the corresponding image bearing drum with the presence of the intermediary transfer belt between the primary transfer roller and drum, the direction in which it comes into contact with the intermediary transfer belt is perpendicular to the moving direction of the intermediary transfer belt. Therefore, if the primary transfer roller is pressed against the image bearing drum while the intermediary transfer belt is being circularly moved, the moving speed of the intermediary transfer belt is significantly affected by the contact between the primary transfer roller and intermediary transfer belt. Thus, if an image is formed immediately after the pressing of the primary transfer roller against the image bearing member, the resultant image is likely to suffer from color deviation and/or abnormality (nonuniformity) in image density.

The problem which the image forming apparatus disclosed in Japanese Laid-open Patent Application 2009-128580 is similar to the above described one. That is, after the primary transferring member of each of the image formation stations Y, M and C is moved in the direction to be moved away from the corresponding image bearing member, it is moved in the direction perpendicular to the moving direction of the intermediary transfer belt to be pressed upon the intermediary transfer belt to be pressed against the image bearing member. Therefore, the moving speed of the intermediary transfer belt is significantly affected by the contact between the primary transfer roller and intermediary transfer belt. Thus, if an image is formed immediately after the placement of the primary transfer roller in contact with the intermediary transfer belt, the resultant image is likely to suffer from color deviation and/or abnormality (nonuniformity) in density.

### SUMMARY OF THE INVENTION

Thus, the primary object of the present invention is to provide an image forming apparatus of the so-called tandem type which can move its intermediary transferring member from its image bearing members without moving its members by which the intermediary transfer belt is supported and tensioned relative to the intermediary transfer belt, being therefore significantly smaller than any image forming apparatus, in the amount of speed change which occurs to the intermediary transfer belt when the intermediary transfer belt is put back into the position for color image formation after being moved away from the position for black-and-white image formation.

According to an aspect of the present invention, there is provided an image forming apparatus comprising a first image forming station for forming a toner image on a first image bearing member; a second image forming station for forming a toner image on a second image bearing member; an intermediary transfer belt for carrying the toner images; a first transfer portion including a first transfer member for transferring the toner image formed on said first image bearing member onto said intermediary transfer belt; a second transfer portion including a second transfer member for transferring the toner image formed on said second image bearing member onto said intermediary transfer belt; an executing portion capable of executing operations in a plurality of modes including a first image forming mode for forming the toner images using said first image forming station and said second image forming station, and a second image forming mode for forming the toner image using said first image forming station without using said second image forming station; a plurality of stretching members supporting said intermediary transfer belt; a supporting unit supporting said stretching member; a supporting member supporting said first transfer member and said second transfer member; and a supporting shaft rotatably supporting said supporting member on said supporting unit so that switching is capable while maintaining said supporting unit, between a first state in which said first transfer member and said second transfer member contact said intermediary transfer belt in the first image forming mode, and a second state in which said first transfer member contacts said intermediary transfer belt and said second transfer member is spaced from said intermediary transfer belt, in the second image forming mode, wherein said supporting shaft is disposed in a range which is downstream of a central portion of said first transfer member which is disposed downstreammost with respect to a moving direction of said intermediary transfer belt and which is remote from a surface of said intermediary transfer belt beyond a plane including the central portion of said first transfer member and parallel with a surface of said intermediary transfer belt facing said first transfer member.

These and other objects, features, and advantages of the present invention will become more apparent upon consideration of the following description of the preferred embodiments of the present invention, taken in conjunction with the accompanying drawings.

### BRIEF DESCRIPTION OF THE DRAWINGS

FIG. 1 is a schematic sectional view of the intermediary transfer unit in the first preferred embodiment of the present invention.

FIG. 2 is a schematic sectional view of a typical image forming apparatus to which the present invention is applicable, and shows the general structure of the apparatus.

FIG. 3 is an external perspective view of the intermediary transfer unit in the first preferred embodiment of the present invention.

FIG. 4 is a perspective view of the intermediary transfer unit in the first preferred embodiment, after the removable of its intermediary transfer belt.

FIG. 5 is a perspective view of the intermediary transfer unit in the first embodiment, after the removal of its main frame in addition to its intermediary transfer belt.

FIG. 6 is a perspective drawing of the interior of the intermediary transfer unit in the first embodiment.

FIG. 7 is a drawing for describing the rotational axis of the primary transfer roller supporting member in the first embodiment.

FIG. 8 is a schematic sectional view of the intermediary transfer unit in the second preferred embodiment of the present invention.

FIG. 9 is a drawing for describing the rotational axis of the primary transfer roller supporting member in the second preferred embodiment.

FIG. 10 is a drawing for describing the rotational axis of the primary transfer roller supporting member in the third preferred embodiment of the present invention.

### DESCRIPTION OF THE PREFERRED EMBODIMENTS

Hereinafter, the preferred embodiments of the present invention will be described in detail with reference to the appended drawings. Not only is the present invention applicable to the image forming apparatuses in the following preferred embodiments of the present invention, but also, those which are partially or entirely different in structure from those in the following preferred embodiments, as long as they are structured so that their primary transferring members can be moved in the direction to be moved away from their image bearing member.

In other words, the present invention is also applicable to an image forming apparatus having no more than three images, or no less than five, bearing members, with which its intermediary transferring member is placed in contact.

In the following description of the preferred embodiments of the present invention, only the main sections of the image forming apparatus, which are related to the formation and transfer of a toner image are going to be described. However, the present invention is applicable to various image forming apparatuses, such as various printing apparatuses, copying machines, facsimile machines, multifunction image forming apparatuses, etc., which are the combinations of the main sections which are going to be described next, and additional devices, equipments, external frames, etc.

### Embodiment 1

(Image Forming Apparatus)

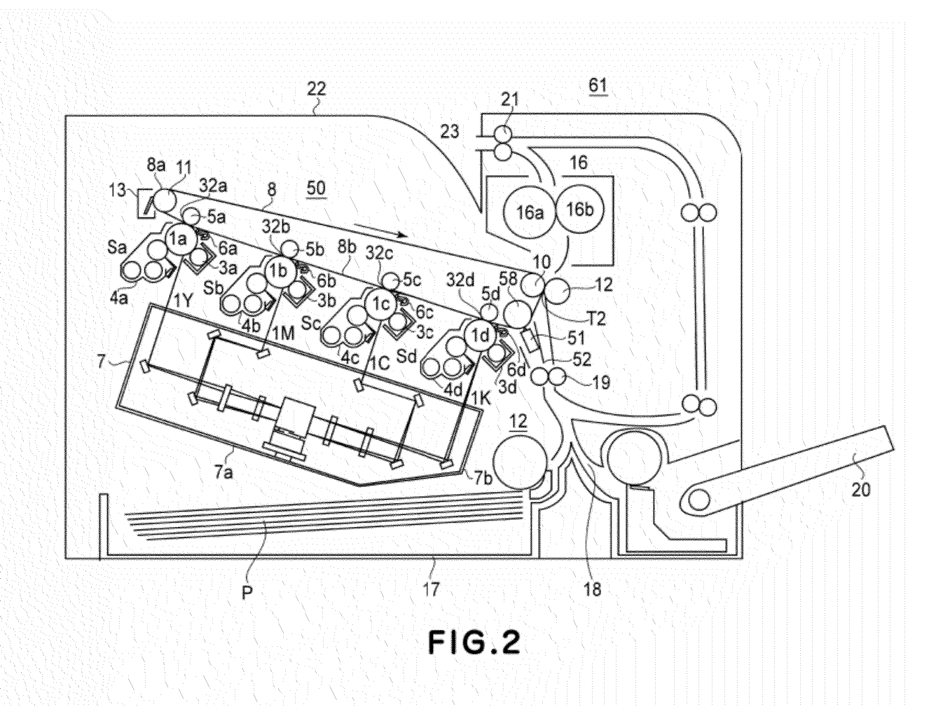

FIG. 2 is a schematic sectional view of the image forming apparatus in this embodiment, and shows the general structure of the apparatus. The image forming apparatus 100 in FIG. 2 is a full-color printer of the so-called tandem type. It has four image formation stations Sa, Sb, Sc and Sd which are aligned in the direction parallel to the moving direction of the intermediary transfer belt 8 of the apparatus 100. In terms of the direction parallel to the moving direction of the intermediary transfer belt 8, the four image formation stations Sa, Sb, Sc and Sd are in a range in which the intermediary transfer belt 8 is straight. The image forming apparatus 100 in FIG. 2 can be operated in the color mode (first image formation mode) or black-and-white mode (second image formation mode). The color mode is for obtaining a multicolor image, and the black-and-white mode is for obtaining a black-and-white image. It is the image formation station Sd, or the most downstream station in terms of the moving direction of the intermediary transfer belt 8, that is used in the black-and-white mode. In the color mode, the image formation stations Sa, Sb and Sc are used in addition to the image formation station Sd.

The image forming stations Sa, Sb, Sc and Sd of the image forming apparatus 100 are provided with photosensitive drums 1a-1d, respectively, as image bearing members. Further, the image forming apparatus 100 is provided with multiple transferring members 5a-5d, which are pressed against the photosensitive drums 1a-1d, one for one, with the presence of the intermediary transfer belt 8 between the transferring members 5a-5d and photosensitive drums 1a-1d, respectively. In the image formation station Sa, or the most upstream station, a yellow toner image is formed on the photosensitive drum 1a, and is transferred (primary transfer) onto the intermediary transfer belt 8 in the primary transfer station 32a. In the image formation station Sb, a magenta toner image is formed on the photosensitive drum 1b, and is transferred (primary transfer) onto the intermediary transfer belt 8 in the primary transfer station 32b, in such a manner that it is layered onto the yellow toner image on the intermediary transfer belt 8.

In the image formation stations Sc and Sd, cyan and black toner images are formed on the photosensitive drums 1c and 1d, respectively, and are transferred (primary transfer) onto the intermediary transfer belt 8 in the primary transfer stations 32c and 32d, respectively, in such a manner that they are sequentially layered onto the yellow and magenta toner images on the intermediary transfer belt 8. After the sequential transfer of the four monochromatic toner images, different in color, onto the intermediary transfer belt 8, the four toner images are conveyed to the secondary transfer station T2, in which they are transferred together (secondary transfer) onto a sheet P of recording medium. The secondary transfer residual toner, that is, the toner remaining on the intermediary transfer belt 8 after being conveyed through the secondary transfer station T2, is removed by a belt cleaning device 13. After the transfer of the four monochromatic toner images, different in color, onto the sheet P of recording medium, the sheet P and the toner images thereon are subjected to heat and pressure by a fixing device 16 of the image forming apparatus 100, whereby the toner images are fixed to the sheet P. Thereafter, the sheet P is discharged into a delivery tray 23 by a pair of discharge rollers 21.

The sheets P of recording medium are taken out one by one from a recoding medium storage cassette 17 while being separated from the rest by a sheet separating device 12. Then, each sheet P is handed over to a pair of registration rollers 19, which convey the sheet P to the second transfer station T2 with such a timing that the sheet P arrives at the second transfer station T2 at the same time as the toner images on the intermediary transfer belt 8.

The four image formation stations Sa, Sb, Sc and Sd are the same in structure, although their developing devices 4a, 4b, 4c and 4d are different in the color of the toner they use (yellow, magenta, cyan and black, respectively). Thus, only the image formation station Sd, that is, the most downstream station, is described. The description of the other stations Sa, Sb and Sc are the same as that of the station Sd except for the suffixes a, b and c, which replace the suffix d of the referential codes for the station Sd.

The image formation station Sd has a photosensitive drum 1d, a charging device 3d, an exposing device 7, a developing device 4d, a primary transfer roller 5d, and a cleaning device 6d. The charging device 3d, exposing device 7, developing device 4d, primary transfer roller 5d, and cleaning device 6d are in the adjacencies of the peripheral surface of the photosensitive drum 1d. The primary transfer roller 5d is an elastic member (its surface layer is formed of elastic substance, and therefore, as it is pressed against photosensitive drum 1, primary transfer nip is formed between itself and photosensitive drum 1). The photosensitive drum 1d and developing device 4d of the image formation station Sd are disposed in a cartridge, making up a process cartridge which makes it easier to maintain the image forming apparatus 100.

The photosensitive drum 1d is made up of a metallic cylinder and a photosensitive layer. The photosensitive layer is formed on the peripheral surface of the metallic cylinder, of a negatively chargeable substance, in such a manner to cover virtually the entirety of the peripheral surface of the metallic cylinder. The photosensitive drum 1 is rotated at a preset process speed (100 mm/sec in peripheral velocity). The charge roller of the charging device 3d is rotated while it is kept pressed upon the peripheral surface of the photosensitive drum 1d. As the charge roller is rotated, a combination of DC and AC voltage is applied to the charge roller, whereby the peripheral surface of the photosensitive drum 1d is uniformly charged. The exposing device 7 deflects, with use of its polygonal mirror, the beam of laser light it emits while modulating (turning on or off) the beam with the image formation data developed from the black monochromatic image (black-and-white image), that is, one of the monochromatic images into which the original was separated, in such a manner that the uniformly charged area of the peripheral surface of the photosensitive drum 1d is scanned by the beam of laser light. Consequently, an electrostatic image is formed on the peripheral surface of the photosensitive drum 1d. The developing device 4d develops the electrostatic image on the photosensitive drum 1d by adhering negatively charged toner to the exposed points of the electrostatic image; it reversely develops the electrostatic image.

The primary transfer roller 5d is pressed against the photosensitive drum 1d, with the presence of the intermediary transfer belt 8 between itself and the peripheral surface of the photosensitive drum 1d, forming thereby the primary transfer station 32d between the photosensitive drum 1d and intermediary transfer belt 8. While the negative charged toner image on the peripheral surface of the photosensitive drum 1d is moved through the primary transfer station 32d, positive DC voltage is applied to the primary transfer roller 5d, whereby the toner image is transferred (primary transfer) onto the intermediary transfer belt 8. The cleaning device 6d removes the transfer residual toner, that is, the toner remaining on the peripheral surface of the photosensitive drum 1d after passing through the primary transfer station Td, to prepare the photosensitive drum 1d for the next toner image formation.

### (Overall Structure of Intermediary Transferring Member)

The intermediary transfer belt 8 is supported and tensioned by three rollers 58, 10 and 11. The roller 58 is a belt driving roller. The roller 10 opposes the secondary transfer roller 12 with the presence of the intermediary transfer belt 8 between itself and roller 12. The roller 11 is a tension roller which provides the intermediary transfer belt 8 with a preset amount of tension. The intermediary transfer belt 8 is circularly moved in the direction indicated by an arrow mark A in FIG. 2, at a preset process speed (peripheral velocity: 100 mm/sec). It is made of dielectric resin, such as polycarbonate, polyethylene terephthalate, polyvinylidene fluoride, or the like.

The secondary transfer roller 12, which is an image transferring member, is pressed again the abovementioned intermediary transfer belt supporting roller 10, with the presence of the intermediary transfer belt 8 between itself and roller 10, forming thereby the secondary transfer station T2 between the intermediary transfer belt 8 and secondary transfer roller 12. A sheet P of recording medium is conveyed through the secondary transfer station T2, while remaining pinched by the intermediary transfer belt 8 and secondary transfer roller 12, with the same timing as the timing with which the area of the intermediary transfer belt 8, across which the toner image is present, is moved through the secondary transfer station T2. While the sheet P, and the negatively charged toner image on the intermediary transfer belt 8, are moved together through the secondary transfer station T2, positive voltage is applied to the secondary transfer roller 12 from an electrical power source, whereby the toner image is transferred (secondary transfer) onto the sheet P.

The portion of the intermediary transfer belt 8, which is between the belt driving roller 58 and secondary transfer station T2 is on the immediately downstream side of the belt driving roller 58 in terms of the moving direction of the intermediary transfer belt 8. Thus, it theoretically slackens. In this embodiment, however, the secondary transfer roller 12 is rotated by a mechanical power source which is independent from the mechanical power source for driving the intermediary transfer belt 8. Therefore, this portion of the intermediary transfer belt 8 remains dynamically stable even during the formation of an image.

The intermediary transfer belt 8, belt driving roller 58, roller 10, tension roller 11, and primary transfer rollers 5a, 5b, 5c and 5d, are integrated as an intermediary transfer unit 50, which is structured so that the intermediary transfer belt 8 continues to be driven even while the image forming apparatus 100 is switched in operational mode from the black-and-white mode to color mode.

### (Internal Structure of Intermediary Transfer Unit)

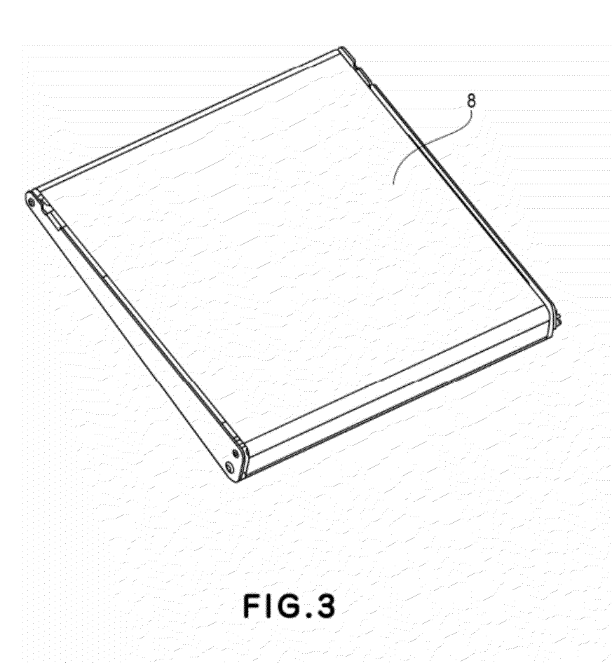

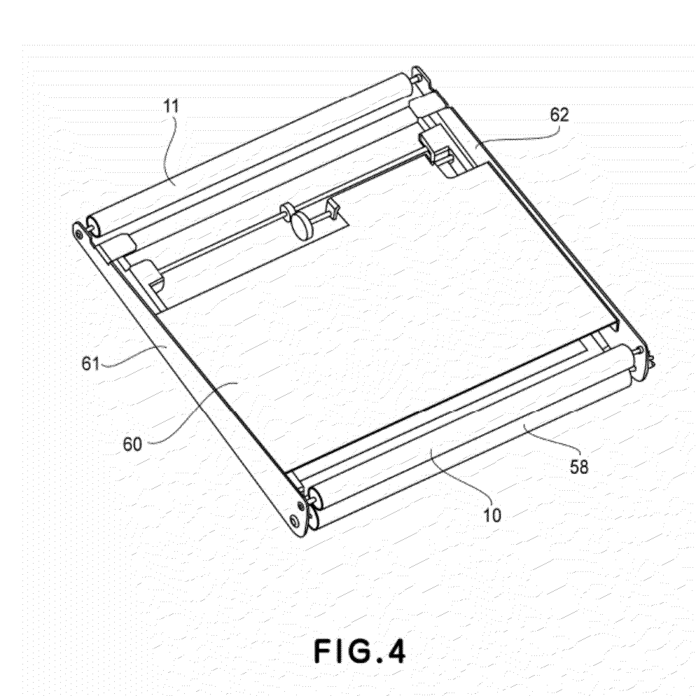

FIG. 3 is an external perspective view of the intermediary transfer unit 50. FIG. 4 is a perspective view of the intermediary transfer unit 50 minus the intermediary transfer belt 8, and shows the structure of the intermediary transfer unit 50. The intermediary transfer unit 50 retains its shape with its lateral plates 61 and 62, and its main frame 60. The belt driving roller 58, roller 10, and tension roller 11 are supported by the lateral plates 61 and 62.

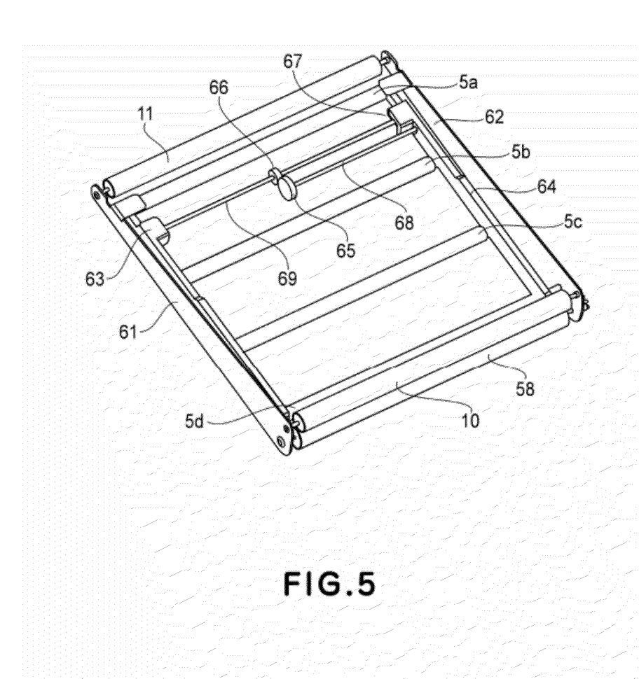

FIG. 5 is a perspective view of the intermediary transfer unit 50 minus the intermediary transfer belt 8 and main frame 60, and shows the structure of the intermediary transfer unit 50. The belt driving roller 58, belt backing roller 10, and tension roller 11 are the members for supporting and keeping tensioned the intermediary transfer belt 8, and are supported by the lateral plates 61 and 62, which are parts of a roller supporting unit. In this embodiment, the roller supporting unit comprises the lateral plates 61 and 62 which support the intermediary transfer belt supporting rollers, a bottom plate, etc., of the intermediary transfer unit 50. The primary transfer rollers 5a-5d are supported by pivotally movable frames 63 and 64.

In this embodiment, the surface layer of at least the primary transfer roller 5d is formed of an elastic substance so that the surface layer of the primary transfer roller 5d can form a transfer nip by being deformed as described previously. However, it is not mandatory that the surface layer of each of the primary transfer rollers 5a, 5b and 5c also is formed of the elastic substance.

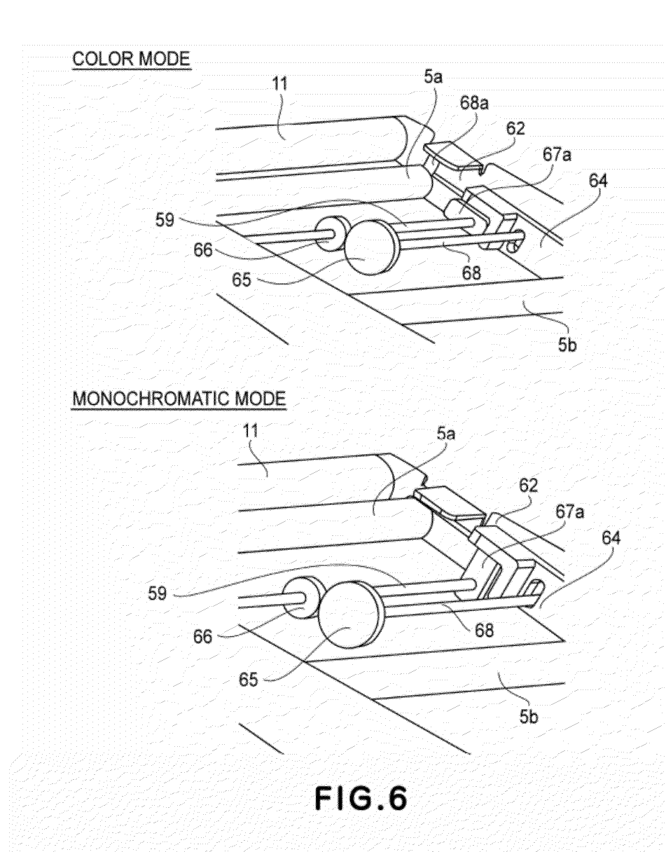

A shaft 68 is rotatable by the driving force inputted by a driving means. It is supported by the unshown lateral plate of the main assembly, and the main frame 60 of the intermediary transfer unit 50. To the inward end of the shaft 68, a gear 65 is attached. The intermediary transfer unit 50 is structured so that as the shaft 68 is rotated, the gear 65 also rotates. A shaft 59 is rotatably attached to the lateral plates 61 and 62. The intermediary transfer unit 50 is structured so that the shaft 59 rotates with a gear 66. To the lengthwise ends of the shaft 59, a pair of cams 67a (FIG. 6) and 67b (unshown) one for one. Further, the intermediary transfer unit 50 is provided with a spring 68a (FIG. 6), which is between the lateral plate 62 and the pivotally movable frame 64 and keeps the primary transfer rollers 5a-5d pressed against the photosensitive drums 1a-1d, with the presence of the pivotally movable frame 64 between itself and primary transfer rollers 5a-5d.

(Operation for Moving Primary Transfer Rollers Away from Photosensitive Drums)

Referring to FIG. 5, the pivotally movable frames 63 and 64, which are supporting members for supporting the primary transfer rollers 5a-5d, are pivotally (rotatably) supported by the lateral plates 61 and 62, which are parts of the primary transfer roller supporting unit. That is, when the pivotally movable frames 63 and 64 are pivotally moved to place the primary transfer rollers 5 in contact with the intermediary transfer belt 8, the lateral plates 61 and 62 (as parts of supporting unit) are not moved. Therefore, the primary transfer rollers 5a-5c can be separated from the intermediary transfer belt 8 with virtually no change in the moving speed of the intermediary transfer belt 8.

In this embodiment, during the separation, the primary transfer rollers 5a-5c, which are the primary transferring members with which the primary transfer stations are provided one for one are moved away from the photosensitive drums 1a-1c which are the primary image bearing members with which the image formation stations are provided, respectively. On the other hand, the primary transfer roller 5d, as the first transferring member, at least the surface layer of which is formed of an elastic substance, remains pressed against the photosensitive drum 1d (as first image bearing member with which first image formation station is provided), in such a manner that its elastic surface layer remains elastically deformed.

FIG. 6 is a drawing for showing the internal movement of the intermediary transfer unit 50 when the image forming apparatus 100 is in the color mode (first image formation mode) and black-and-white mode (second image formation mode). In the color mode, the cam 67a which is a means for moving the primary transfer roller supporting members is kept separated from the cam contacting portion 64a of the pivotally movable frame 64, and the primary transfer rollers 5a-5d are kept pressed against the photosensitive drums 1a-1d, respectively, by the spring 68a, with the presence of the pivotally movable frame 64 between itself and spring 68a. In the black-and-white mode, the cam 67a is in contact with the cam contacting portion 64a of the pivotally movable frame 64 (cam 67a was rotated into this position for black-and-white mode), and is kept lifted by the spring 68a in the direction indicated by an arrow mark. The cam 67b, pivotally movable frame 63, and spring 68b on the opposite side of the intermediary transfer unit 50 are similar in position and movement as the cam 67a, pivotally movable frame 64, and spring 68a described above.

When it is necessary to switch the image forming apparatus 100 in operational mode from the color mode to the black-and-white mode, the shaft 68 and gear 65 are rotated by an unshown driving means. Since the gear 65 is in mesh with the gear 66, the gear 66, shaft 59, and cam 67a rotate together. Thus, the cam 67a, which remained separated from the pivotally movable frame 64, comes into contact with the pivotally movable frame 64. On the other hand, when it is necessary to switch the image forming apparatus 100 in operational mode from the black-and-white mode to the color mode, the shaft 68 is reversely rotated, whereby the cam 67a which is in contact with the pivotally movable frame 64 is separated from the pivotally movable frame 64. As for the means for rotating the shaft 68, it is easiest to use a stepping motor and pulse-control the stepping motor. However, it is not limited to the combination of a stepping motor and pulse-control.

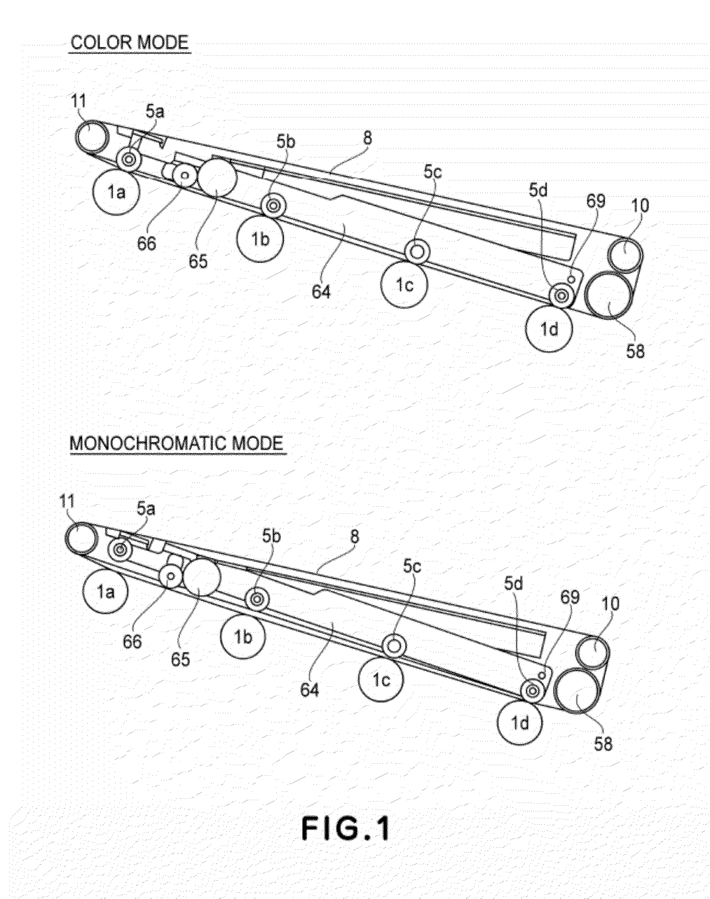

FIG. 1 is a combination of a schematic sectional view of the intermediary transfer unit 50 and photosensitive drums 1a-1d in the color mode, and a schematic sectional view of the intermediary transfer unit 50 and photosensitive drums 1a-1d in the black-and-white mode. The pivotally movable frame 64 is pivotally movable about the axial line 69 of the pivotally movable frame supporting shaft, to switch the image forming apparatus 100 in operation mode between the color mode and black-and-white mode. That is, as the image forming apparatus 100 is put in the color mode, the pivotally movable frame 64 which is a member for supporting the multiple primary transferring members is moved by the cam 67a, which is the means for moving the pivotally movable frame moving means, in the first direction, that is, toward the intermediary transfer belt 8, whereas as the image forming apparatus 100 is put in the black-and-white mode, the pivotally movable frame 64 is moved in the second direction, that is, the opposite direction of the first direction.

The shape of the loop which the intermediary transfer belt 8 forms is determined by the tension roller 11, primary transfer roller 5d, belt driving roller 58, and belt backing roller 10. In the case of the image forming apparatus 100 in the first embodiment shown in FIG. 1, the loop shape remains the same whether the image forming apparatus 100 is in the color mode or black-and-white mode. The portion of the intermediary transfer belt 8 between the tension roller 11 and the belt driving roller 58, remains straight. However, in the black-and-white mode, the photosensitive drums 1a-1c are idled to allow the intermediary transfer belt 8 to smoothly move.

### (Axis of Pivotal Movement of Frames 63 and 64)

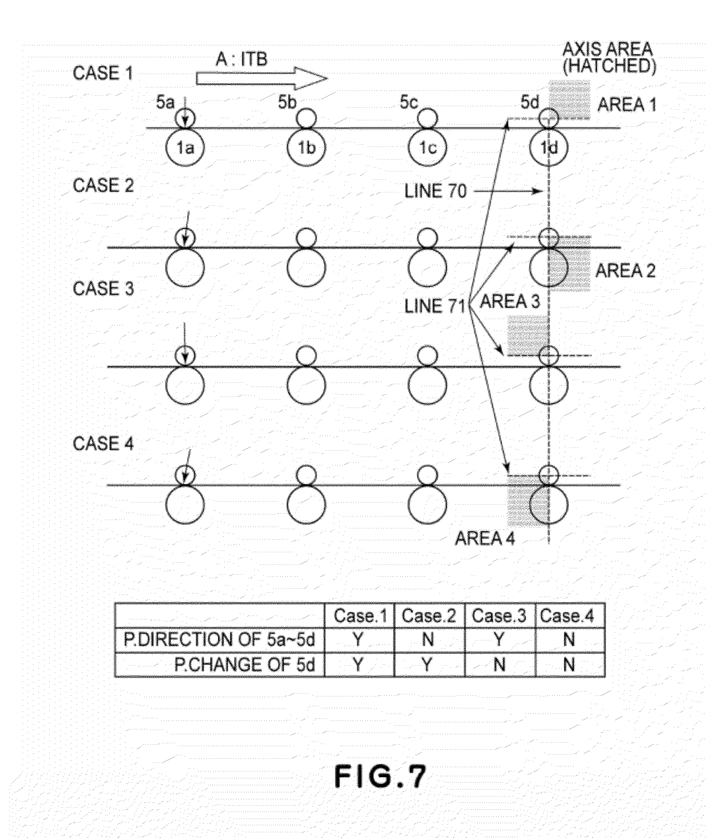

At this time, the position of the rotational axis 69 is described in detail. FIG. 7 is a drawing which shows the relationship between the directions in which the primary transfer rollers 5a-5c are moved toward the photosensitive drums 1a-1c, respectively, and the position of the rotational axis of each of the pivotally movable frames 63 and 64. Given next are the results of the studies of the four cases different in the position of the rotational axis of each of the pivotally movable frames 63 and 64.

First, the four cases are described. The area around the first primary roller 5d, or the most downstream primary transfer roller in terms of the moving direction of the intermediary transfer belt 8, can be divided into four areas 1-4 by a line 70 which coincides with the rotational axis of the primary transfer roller 5d and is perpendicular to the intermediary transfer belt 8, and a line 71 (equivalent to plane parallel to belt 8) which coincides with the rotational axis of the primary transfer roller 5d and is perpendicular to the line 70. Here, the “belt surface” means the surface of the portion of the intermediary transfer belt 8 which is kept tensioned by the belt driving roller 58 and tension roller 11. That is, it is the surface of the portion of the intermediary transfer belt 8 which is kept tensioned by multiple tension providing members.

In the case 1, the rotational axis 69 is in the downstream area 1. Thus, when the primary transfer rollers 5a-5c are pressed against the photosensitive drums 1a-1c, respectively, the contact pressure between the intermediary transfer belt 8 and each of the rollers 5a-5c has a vectorial component which is the same in direction as the moving direction A of the intermediary transfer belt 8. As for the primary transfer roller 5d, it is moved in the direction to be pressed against the photosensitive drum 1d.

In the case 2, the rotational axis 69 is in the downstream area 2. Thus, when the primary transfer rollers 5a-5c are pressed against the photosensitive drums 1a-1c, respectively, the contact pressure between the intermediary transfer belt 8 and each of the rollers 5a-5c has a vectorial component which is opposite in direction from the moving direction A of the intermediary transfer belt 8. As for the primary transfer roller 5d, it is moved in the direction to be pressed against the photosensitive drum 1d.

In the case 3, the rotational axis 69 is in the area 3. Thus, when the primary transfer rollers 5a-5c are pressed against the photosensitive drums 1a-1c, respectively, the contact pressure between the intermediary transfer belt 8 and each of the rollers 5a-5c has a vectorial component which is the same in direction as the moving direction A of the intermediary transfer belt 8. As for the primary transfer roller 5d, it is moved in the direction to be moved away from the photosensitive drum 1d.

In the case 4, the rotational axis 69 is in the area 4. Thus, when the primary transfer rollers 5a-5c are pressed against the photosensitive drums 1a-1c, respectively, the contact pressure between the intermediary transfer belt 8 and each of the rollers 5a-5c has a vectorial component which is opposite in direction from the moving direction A of the intermediary transfer belt 8. As for the primary transfer roller 5d, it is moved in the direction to be moved away the photosensitive drum 1d.

If the contact pressure generated between the intermediary transfer belt 8 and each of the primary transfer rollers 5a-5c when the primary transfer rollers 5a-5c are moved in the direction to be pressed against the photosensitive drums 1a-1c, respectively, while the intermediary transfer belt 8 is being moved, has a vectorial component opposite in direction from, or perpendicular to, the moving direction A of the intermediary transfer belt 8, the amount of load to which the intermediary transfer belt 8 is being subjected while being circularly moved is substantially changed by the contact between the rollers 5a-5c and belt 8 the moment when each of the primary transfer rollers 5a-5c comes into contact with the intermediary transfer belt 8, which in turn significantly changes the intermediary transfer belt 8 in speed, causing the image forming apparatus 100 to output an image which suffers from color deviation and/or abnormality in density. Further, unless the pressure applied to the photosensitive drum 1d by the primary transfer roller 5d is kept at a proper level, the toner image on the photosensitive drum 1d fails to be properly transferred onto the intermediary transfer belt 8. That is, the escape of the pressure applied to the photosensitive drum 1d by the primary transfer roller 5d results in the primary transfer failure of a black toner image.

That is, it is only the case 1 that can provide an image transferring system which can prevent the intermediary transfer belt 8 from changing in speed, and also, can make the image forming apparatus 100 output a satisfactory image when the apparatus 100 is in the black-and-white mode. In this embodiment, therefore, the intermediary transfer unit 50 is structured so that the rotational axis 69 is in the area 1 (case 1). That is, when it is necessary for the primary transfer rollers 5a-5c to be pressed against, or moved away from, the photosensitive drums 1a-1c, with the presence of the intermediary transfer belt 8 between themselves and photosensitive drums 1a-1c, respectively, while the primary transfer roller 5d is kept pressed against the photosensitive drum 1d, with the presence of the intermediary transfer belt 8 between itself and photosensitive drum 1d, the case 1 is preferable.

According to this embodiment, it is possible for the transferring members to be pressed against, or moved away from, the image bearing members, one for one, without changing in shape the loop which the intermediary transfer belt 8 forms. Therefore, the intermediary transfer unit 50 in this embodiment can be compact in size. Further, according to this embodiment, the transferring members can be moved away from the image bearing members, one for one, without moving the members which support and keep tensioned the intermediary transfer belt 8, relative to the intermediary transfer belt 8, and also, minimizing the amount of change in the speed of the intermediary transfer belt 8. Further, the contact pressure between the intermediary transfer belt 8 and each of the transferring members has a vectorial component which is the same in direction as the moving direction of the intermediary transfer belt 8. Therefore, the change which occurs to the speed of the intermediary transfer belt 8 when the transferring members come into contact with the intermediary transfer belt 8 can be minimized. Therefore, even if the image forming apparatus 100 is switched in operational mode from the black-and-white mode to the color mode during the secondary transfer operation while the intermediary transfer belt 8 is being driven, the image forming apparatus 100 can output a high quality image, that is, an image which is virtually free of color deviation and/or abnormality (nonuniformity) in image density.

### Embodiment 2

In the first embodiment, all of the multiple primary transferring members are supported together by the primary transferring member supporting members. In this embodiment, all the primary transferring members used in the color mode, except the primary transferring member used in the black-and-white mode, are supported together by the primary transfer member supporting members.

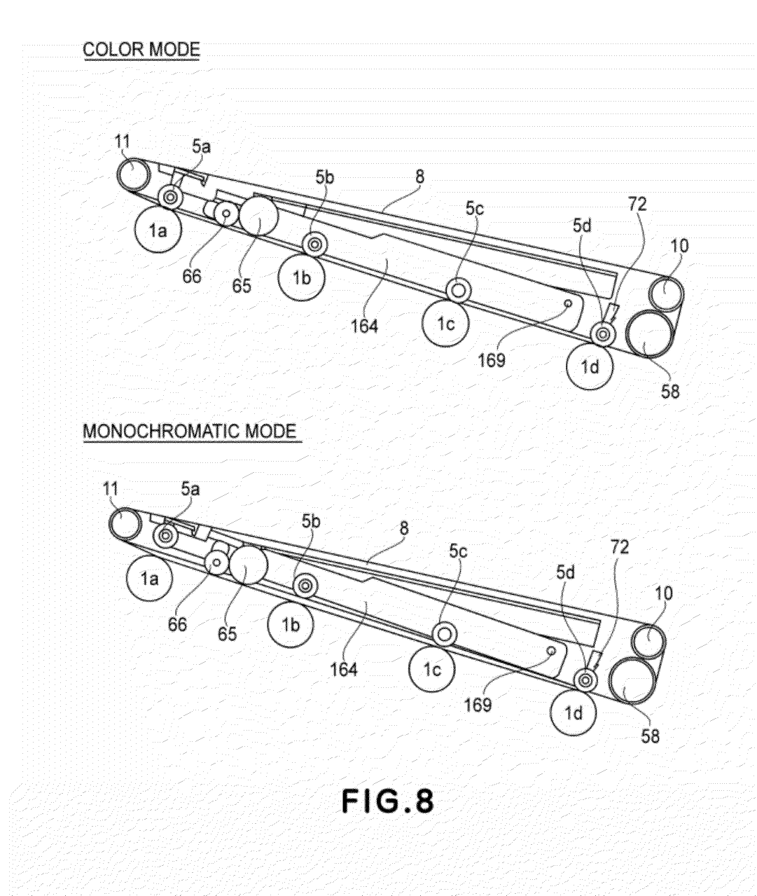

FIG. 8 is a combination of a schematic sectional view of the intermediary transfer unit 50 and photosensitive drums 1a-1d in this embodiment, in the color mode, and a schematic sectional view of the intermediary transfer unit 50 and photosensitive drums 1a-1d in the black-and-white mode. FIG. 8 is different from FIG. 1 in that the primary transfer rollers 5a-5c are supported together by the pivotally movable frames 163 and 164, whereas the primary transfer roller 5d is supported by unshown lateral plates 61 and 62 and is kept pressed against the photosensitive drum 1d by a spring 72. The interior of the intermediary transfer unit 50 in this embodiment is similar to that of the intermediary transfer unit 50 in this first embodiment.

That is, also in this embodiment, the belt driving roller 58, belt backing roller 10, and tension roller 11 are the members which support and keep tensioned the intermediary transfer belt 8. They are supported by the lateral plates 61 and 62. In this embodiment, however, the lateral plate 61 and 62 (which makes up supporting unit) support the primary transfer roller 5d (first transferring member) as well. The primary transfer rollers 5a-5c (primary transferring members) are supported by the pivotally movable frames 163 and 164 as supporting members.

Also in the second embodiment, the pivotally movable frames 163 and 164 are pivotally supported by the lateral plates 61 and 62 (which make up supporting unit) as in the first embodiment. That is, when the pivotally movable frames 63 and 64 are pivotally moved to place the primary transfer rollers 5 in contact with the intermediary transfer belt 8, the lateral plates 61 and 62 (as parts of supporting unit) are not moved relative to the pivotally movable frames 163 and 164. Therefore, the change which occurs to the speed of the intermediary transfer belt 8 when the primary transfer rollers 5a-5c are placed in contact with, or moved away from, the intermediary transfer belt 8 is minimized.

In this embodiment, it is unnecessary for the surface layer of at least the primary transfer roller 5d to be formed of an elastic member substance so that as the primary transfer roller 5d is pressed against the photosensitive drum 1d, the surface layer of the roller 5d forms a transfer nip by being deformed by the peripheral surface of the photosensitive drum 1d as described before.

As the image forming apparatus 100 begins to be shifted in operational mode from the color mode to the black-and-white mode, the pivotally movable frames 163 and 164 are rotationally moved about the rotational axis 169, causing thereby the primary transfer rollers 5a-5c to move in the direction to be moved away from the photosensitive drums 1a-1c, respectively.

Referring to FIG. 8 which is a combination of a schematic sectional view of the intermediary transfer unit 50 and photosensitive drums 1a-1d in this embodiment, in the color mode, and a schematic sectional view of the intermediary transfer unit 50 and photosensitive drums 1a-1d in the black-and-white mode, the rotational axis 169, which is the axial line of the pivotally movable frame supporting shaft, is offset from the primary transferring member 5c, which belongs to the immediately upstream image formation station of the most downstream image formation station, in terms of the moving direction of the intermediary transfer belt 8. In this embodiment, the primary transfer roller 5d, which is the most downstream primary transfer roller 5d is not affected in position by the pivotal movement of the pivotally movable frames 163 and 164. Thus, the contact pressure between the primary transfer roller 5d and intermediary transfer belt 8 (photosensitive drum 1d) in the color mode is not different from that in the black-and-white mode.

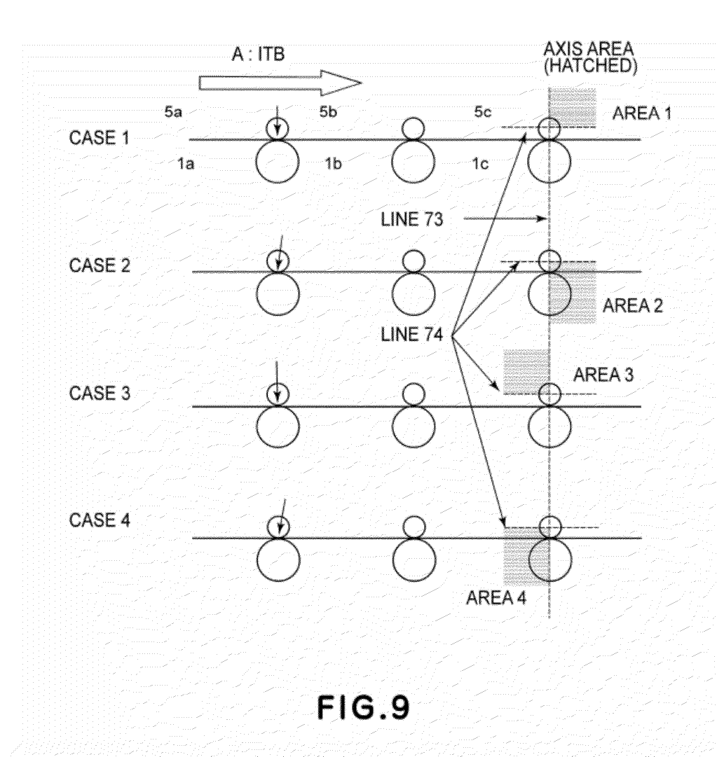

FIG. 9 is a drawing for describing the relationship between the directions in which the primary transfer rollers 5a-5c are moved toward the photosensitive drums 1a-1c, respectively, and the position of the rotational axis 169 of each of the pivotally movable frames 163 and 164. Given next are the results of the studies of the four cases which are different in the position of the rotational axis 169 of each of the pivotally movable frames 163 and 164.

Here, the studies are described with reference to the primary transfer roller 5c, which is the most downstream primary transfer roller among the primary transfer rollers 5a-5c. The area around the first primary roller 5c can be divided into four areas 1-4 by a line 73 which coincides with the rotational axis of the primary transfer roller 5c and is perpendicular to the intermediary transfer belt 8, and a line 74 (equivalent to plane parallel to belt 8) which coincides with the rotational axis of the primary transfer roller 5c and is perpendicular to the line 73. The relationship between the primary transfer roller 5d which is the most downstream primary transfer roller among the four primary transfer rollers, and the photosensitive drum 1d, is not affected by in which of four areas the rotational axis 169 is present.

In the case 1, the rotational axis 169 is in the area 1. Thus, when the primary transfer rollers 5a-5c are pressed against the photosensitive drums 1a-1c, respectively, the contact pressure between the intermediary transfer belt 8 and each of the rollers 5a-5c has a vectorial component which is the same in direction as the moving direction A of the intermediary transfer belt 8.

In the case 2, the rotational axis 169 is in the area 2. Thus, when the primary transfer rollers 5a-5c are pressed against the photosensitive drums 1a-1c, respectively, the contact pressure between the intermediary transfer belt 8 and each of the rollers 5a-5c has a vectorial component which is opposite in direction from the moving direction A of the intermediary transfer belt 8. In the case 3, the rotational axis 169 is in the area 3. Thus, when the primary transfer rollers 5a-5c are pressed against the photosensitive drums 1a-1c, respectively, the contact pressure between the intermediary transfer belt 8 and each of the rollers 5a-5c has a vectorial component which is the same in direction as the moving direction A of the intermediary transfer belt 8.

In the case 4, the rotational axis 169 is in the area 4. Thus, when the primary transfer rollers 5a-5c are pressed against the photosensitive drums 1a-1c, respectively, the contact pressure between the intermediary transfer belt 8 and each of the rollers 5a-5c has a vectorial component which is opposite in direction from the moving direction A of the intermediary transfer belt 8.

If the intermediary transfer belt 8 is being moved, and the contact pressure generated between the intermediary transfer belt 8 and each of the primary transfer rollers 5a-5c while the primary transfer rollers 5a-5c are moved in the direction to be pressed against the photosensitive drums 1a-1c, respectively, has a vectorial component opposite in direction from, or perpendicular to, the moving direction A of the intermediary transfer belt 8, the amount of load to which the intermediary transfer belt 8 is being subjected while being circularly moved is substantially changed the moment when each of the primary transfer rollers 5a-5c comes into contact with the intermediary transfer belt 8, which in turn significantly changes the intermediary transfer belt 8 in speed, causing the image forming apparatus 100 to output an image which suffers from color deviation and/or abnormality in density. This embodiment is different from the first embodiment in that in this embodiment, when the image forming apparatus 100 is switched in operational mode from the color mode to the black-and-white mode, or the black-and-white mode to the color mode, the relationship between the primary transfer roller 5d and photosensitive drum 1d does not change.

That is, it is only the cases 1 and 3 that can provide an image transferring system which can prevent the intermediary transfer belt 8 from changing in speed, and can make the image forming apparatus 100 output a satisfactory image when the apparatus 100 is in the black-and-white mode. In this embodiment, therefore, the intermediary transfer unit 50 is structured so that the rotational axis 169 is in the area 1 (case 1). However, even if the intermediary transfer unit 50 is structured so that the rotational axis 169 is in the area 3, the above-mentioned direction of the vectorial component of the contact pressure generated between the intermediary transfer belt 8 and each of the primary transfer rollers 5a-5c as the rollers 5a-5c are pressed against the photosensitive drums 1a-1c, respectively, is the same as that in the case 1. However, if the intermediary transfer unit 50 is structured so that the rotational axis 169 is in the area 3, as the upstream transfer rollers 5 relative to the rotational axis 169 in terms of the moving direction of the intermediary transfer belt 8 are moved in the direction to be pressed against the corresponding photosensitive drums, one for one, the downstream transfer roller is moved in the direction to be moved away from the corresponding photosensitive drum 1, and vice versa. Therefore, there occurs unbalance in contact pressure among the multiple primary transfer rollers 5. Therefore, it is desired that the intermediary transfer unit 50 is structured so that the rotational axis 169 is in the are 1 (case 1).

### Embodiment 3

This embodiment is similar to the second embodiment. That is, all the multiple transferring members used in the color mode are supported together by the same supporting members, except for the transferring member used also in the black-and-white mode. The transferring member used also in the black-and-white mode is always kept pressed against the photosensitive drum used also in the black-and-white mode, with the presence of the intermediary transfer belt between the intermediary transfer belt 8 and photosensitive drum, as in the second embodiment. This embodiment is different from the second embodiment in that in the second embodiment, the intermediary transfer unit 50 is structured so that the rotational axis of the shaft of the primary transferring member supporting member was closer to the transfer roller 5c than to the transfer roller 5d which is the most downstream transfer roller, whereas in this embodiment, it is closer to the transfer roller 5d than to the transfer roller 5d. Even in this case, the intermediary transfer unit 50 is structured so that the rotational axis is in the area 1, that is, one of the four areas into which the area adjacent to the primary transfer roller 5c can be divided by a line 73 which coincides with the axial line of the roller 5c and is perpendicular to the intermediary transfer belt 8, and a line 74 which coincides with the axial line of the roller 5c and is perpendicular to the line 73.

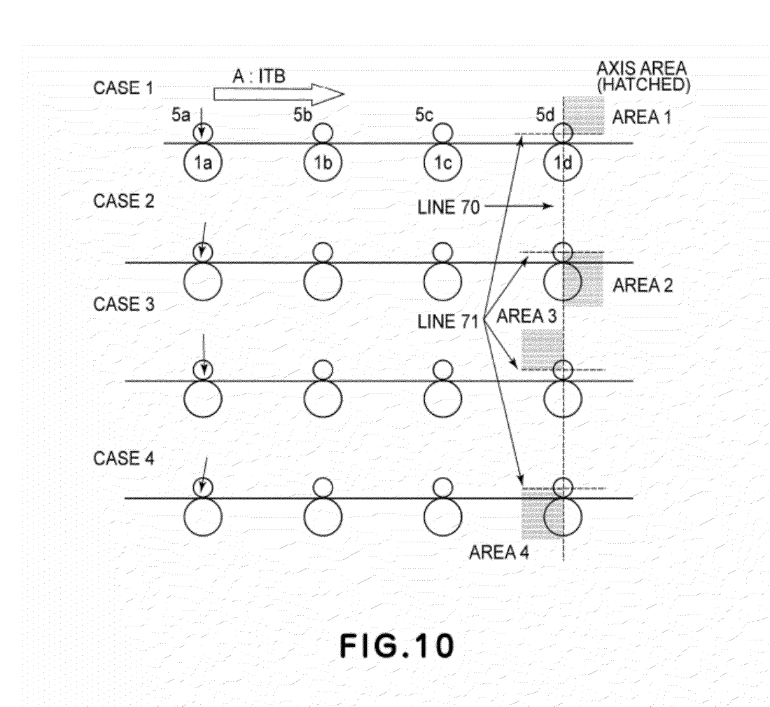

FIG. 10 is a combination of a schematic sectional view of the intermediary transfer unit 50 and photosensitive drums 1a-1d in this embodiment, in the color mode, and a schematic sectional view of the intermediary transfer unit 50 and photosensitive drums 1a-1d in the black-and-white mode.

In the case 1, the rotational axis 69 is in the area 1. Thus, when the primary transfer rollers 5a-5c are pressed against the photosensitive drums 1a-1c, respectively, the contact pressure between the intermediary transfer belt 8 and each of the rollers 5a-5c has a vectorial component which is the same in direction as the moving direction A of the intermediary transfer belt 8.

In the case 2, the rotational axis 169 is in the area 2. Thus, when the primary transfer rollers 5a-5c are pressed against the photosensitive drums 1a-1c, respectively, the contact pressure between the intermediary transfer belt 8 and each of the rollers 5a-5c has a vectorial component which is opposite in direction from the moving direction A of the intermediary transfer belt 8. In the case 3, the rotational axis 169 is in the area 3. Thus, when the primary transfer rollers 5a-5c are pressed against the photosensitive drums 1a-1c, respectively, the contact pressure between the intermediary transfer belt 8 and each of the rollers 5a-5c has a vectorial component which is the same in direction as the moving direction A of the intermediary transfer belt 8.

In the case 4, the rotational axis 169 is in the area 4. Thus, when the primary transfer rollers 5a-5c are pressed against the photosensitive drums 1a-1c, respectively, the contact pressure between the intermediary transfer belt 8 and each of the rollers 5a-5c has a vectorial component which is opposite in direction from the moving direction A of the intermediary transfer belt 8.

As described above, it is evident that the cases 2 and 4, in which the rotational axis 169 is not in the area 1 in FIG. 9, are not desirable. On the other hand, the cases 1 and 3 in this embodiment, in which the rotational axis 169 is in the area 1 in FIG. 9, can minimize the change in the speed of the intermediary transfer belt 8, and therefore, can make the image forming apparatus 100 output a satisfactory image, when the apparatus 100 is in the black-and-white mode. That is, the intermediary transfer unit 50 is to be structured so that the rotational axis 169 is in the area 1 or 3.

In the case 1, intermediary transfer unit 50 is desired to be structured so that the rotational axis, which is the axial line of the supporting member, is outside the adjacent area of the transferring member 5d of the most downstream image formation station. Further, in the case 3, the rotational axis 169 was closer to the primary transfer roller 5d than to the primary transfer roller 5c. However, the intermediary transfer unit 50 may be structured so that the rotational axis 169 is closer to the primary transfer roller 5c, which is the immediately upstream primary transfer roller of the primary transfer roller 5d, than to the primary transfer roller 5d.

### (Modified Versions of Preceding Embodiments)

In each of the preceding embodiments of the present invention, the image forming apparatus 100 was provided with multiple primary image bearing members and multiple primary transferring members in order for the apparatus 100 to be enabled to form a full-color image. However, the present invention is also applicable to an image forming apparatus provided with only a single primary image bearing member and a single primary transferring member in order for the apparatus to form a monochromatic color image. Also in this case, the intermediary transfer unit is to be structured, as in the preceding embodiments, so that when the apparatus is switched in operational mode, preselected transferring members are orbitally moved together while the unit which supports the members for supporting and keeping tensioned the intermediary transfer belt is kept unchanged in shape. Thus, the transferring members can be moved in the direction to be moved away from the corresponding image bearing members, one for one, without changing in position the members which support and keep tensioned the intermediary transfer belt, and therefore, minimizing the change which occurs to the speed of the intermediary transfer belt when moving the primary transferring member in the direction to be moved away from the image bearing members. Further, the transferring members are placed in contact with the intermediary transfer belt in such a direction that the contact pressure between the intermediary transfer belt and each of the primary transferring members has a vectorial component which is the same in direction as the moving direction A of the intermediary transfer belt. Therefore, it is possible to minimize the change which occurs to the speed of the intermediary transfer belt when the primary transferring members come into contact with the belt.

Incidentally, the present invention is also applicable to an image forming apparatus which incorporates, as necessary, the technical items of the image forming apparatuses in the preceding preferred embodiments of the present invention, and their modifications.

As will be evident from the detailed description of the preferred embodiments of the present invention given above, according to the present invention, when the primary transferring members of a color image forming apparatus have to be moved in the direction to be moved away from, or pressed against, the corresponding image bearing members, one for one, the primary transferring members can be moved without moving the members which support and keep tensioned the intermediary transfer belt, relative to each other. Therefore, an image forming apparatus in accordance with the present invention is significantly smaller than an image forming apparatus in accordance with the prior art, in the amount of the change which occurs to the speed of the intermediary transfer belt when the primary transferring members are changed in position.

While the invention has been described with reference to the structures disclosed herein, it is not confined to the details set forth, and this application is intended to cover such modifications or changes as may come within the purposes of the improvements or the scope of the following claims.

This application claims priority from Japanese Patent Application No. 034487/2011 filed Feb. 21, 2011 which is hereby incorporated by reference.

What is claimed is:

1. An image forming apparatus comprising:
a first image forming station for forming a toner image on a first image bearing member;
a second image forming station for forming a toner image on a second image bearing member;
an intermediary transfer belt for carrying the toner images;
a first transfer portion including a first transfer member for transferring the toner image formed on said first image bearing member onto said intermediary transfer belt;
a second transfer portion including a second transfer member for transferring the toner image formed on said second image bearing member onto said intermediary transfer belt;
an executing portion capable of executing operations in a plurality of modes including a first image forming mode for forming the toner images using said first image forming station and said second image forming station, and a second image forming mode for forming the toner image using said first image forming station without using said second image forming station;
a plurality of stretching members supporting said intermediary transfer belt;
a supporting unit supporting said stretching member;
a supporting member supporting said first transfer member and said second transfer member; and
a supporting shaft rotatably supporting said supporting member on said supporting unit so that switching is capable while maintaining said supporting unit, between a first state in which said first transfer member and said second transfer member contact said intermediary transfer belt in the first image forming mode, and a second state in which said first transfer member contacts said intermediary transfer belt and said second transfer member is spaced from said intermediary transfer belt, in the second image forming mode,
wherein said supporting shaft is disposed in a range which is downstream of a central portion of said first transfer member which is disposed downstreammost with respect to a moving direction of said intermediary transfer belt and which is remote from a surface of said intermediary transfer belt beyond a plane including the central portion of said first transfer member and parallel with a surface of said intermediary transfer belt facing said first transfer member.

2. An apparatus according to claim 1, further comprising a stretching roller disposed downstream of said first transfer member with respect to the rotational moving direction of said intermediary transfer belt, wherein said supporting shaft is disposed between said stretching roller and said first transfer member.

3. An apparatus according to claim 1, wherein said executing portion is capable of switching the operation from the second image forming mode to the first image forming mode during rotation of said intermediary transfer belt.

4. An image forming apparatus comprising:
an intermediary transfer belt;
a plurality of stretching members supporting said intermediary transfer belt;
first image forming means, including a first image bearing member, for forming a toner image on said first image bearing member;
second image forming means, including a plurality of image bearing members, for forming toner images on said image bearing members, respectively;
a first transfer member for transferring the toner image formed on said first image bearing member onto said intermediary transfer belt;
a plurality of second transfer members for transferring the toner images formed on said image bearing members onto said intermediary transfer belt;
an executing portion capable of executing operations in a plurality of modes including a first image forming mode for forming the toner images using said first image forming station and said second image forming station, and a second image forming mode for forming the toner image using said first image forming stations without using said second image forming station;
a supporting unit supporting said stretching members and said first transfer member;
a supporting member supporting said second transfer members; and
a supporting shaft rotatably supporting said supporting member on said supporting unit so that switching is capable while maintaining said supporting unit, between a first state in which said first transfer member and said second transfer members contact said intermediary transfer belt in the first image forming mode, and a second state in which said first transfer member contacts said intermediary transfer belt and said second transfer members are spaced from said intermediary transfer belt, in the second image forming mode,
wherein said supporting shaft is disposed in a range which is downstream of a central portion of such one of said second transfer members as is disposed downstreammost with respect to a moving direction of said intermediary transfer belt and which is remote from a surface of said intermediary transfer belt beyond a plane including the central portion of said downstreammost transfer member and parallel with a surface of said intermediary transfer belt facing said downstreammost transfer member.

5. An apparatus according to claim 4, wherein said supporting shaft is disposed downstream of said second transfer members and upstream of said first transfer member with respect to a rotational moving direction of said intermediary transfer belt.

6. An apparatus according to claim 4, wherein said supporting shaft is disposed downstream of said first transfer member which is disposed downstream of said second transfer members.

7. An apparatus according to claim 4, wherein said executing portion is capable of switching the operation from the second image forming mode to the first image forming mode during rotation of said intermediary transfer belt.
